(19) United States
(12) Patent Application Publication
(10) Pub. No.: US 2008/0246003 A1
(43) Pub. Date: Oct. 9, 2008

(54) Thermodynamically Stable Solutions Of Chalcogenide-Bound Lanthanide Compounds With Improved Quantum Efficiency

(75) Inventors: Richard E. Riman, Belle Mead, NJ (US); Gangadharan A. Kumar, New Brunswick, NJ (US); John G. Brennan, Highland Park, NJ (US)

Correspondence Address: SYNNESTVEDT LECHNER & WOODBRIDGE LLP, P O BOX 592, 112 NASSAU STREET, PRINCETON, NJ, 08542-0592, US

(73) Assignee: RUTGERS, THE STATE UNIVERSITY OF NEW JERSEY, New Brunswick, NJ (US)

(21) Appl. No.: 11/911,841

(22) PCT Filed: Apr. 19, 2006
(86) PCT No.: PCT/US06/14747

§ 371 Date: Oct. 18, 2007

Related U.S. Application Data
(60) Provisional application No. 60/672,539, filed on Apr. 19, 2005.

(51) Int. Cl. C09K 11/84

(52) U.S. Cl. 252/301.4 H

(57) ABSTRACT

Thermodynamically stable solutions of chalcogenide-bound Ln compounds with one or more Ln ions coordinated or bound by chalcogenolate, chalcogenide or polychalcogenido ligands by means of the ligand chalcogenide atom, wherein the Ln compounds are dissolved at a level up to about 90 vol. % in a host solvent optically transparent to wavelengths at which excitation, fluorescence or luminescence of the Ln ions occurs.

### CROSS-REFERENCE TO RELATED APPLICATION

The present invention claims priority benefit under 35 U.S.C. §119(e) of U.S. Provisional Patent Application No. 60/672,539 filed Apr. 19, 2005, the disclosure of which is incorporated by reference.

### GOVERNMENT LICENSE RIGHTS

The U.S. Government has a paid-up license in this invention and the right in limited circumstances to require the patent owner to license others on reasonable terms as required by the terms of Grant No. CHE-00303075 awarded by the NSF and Grant No. N66001-8933 awarded by DARPA.

### BACKGROUND OF THE INVENTION

The present invention relates to thermodynamically stable solutions of chalcogenide-bound lanthanide (Ln) compounds with improved quantum efficiency. In particular the present invention relates to thermodynamically stable solutions in which the Ln compounds and their solutions are lyophillic colloids. The present invention also relates to luminescent devices incorporating the thermodynamically stable Ln compound solutions.

Nanomaterials currently captivate the materials world with the promise of exciting applications in science and technology. The dramatic improvements of the physical and chemical properties in the nano-regime presage the application of nanocomposite materials for the fabrication of optical, electronic and biological devices.

The use of nanocomposites for applications such as optical telecom depends upon the processing of nanostructured components that can be mixed in a polymer host that has low attenuation in the telecommunications window (1500-1700 nm). Such components could be nanoparticles containing a rare earth dissolved in a low phonon energy host or a soluble molecular lanthanide compound.

The ability to process these materials as films fibers, and bulk materials offer a wide range of uses beyond optical telecom, which include displays, taggants and low power lasers. Processing with polymers affords the ability to inexpensively and easily integrate these functional materials as integrated photonic materials.

The incorporation of molecular rare earth compounds into polymers has appeared in many prior reports. Most of this effort has focused on the chemistry of lanthanide (Ln) chelate compounds doped into polymer matrices, i.e. Nd (HFA-D)₃ in PMMA, neodymium octanoate (Nd(OCA)₃) in PMMA, Ndtetrakis (benzoyltrifluoroacetonate) in various matrices, Er (DBM)₃phen in PMMA, Er poly (perfluorobutenylvinylether) in (PF-plastic), Er tetrakis (benzoyltrifluoroacetonate) in various organic hosts, Eu (TFAA)₃ in PMMA, and Eu (DBM)₃ in PMMA. A summary of the optical properties of most of the plastic optical fibers containing lanthanide complexes can be seen in the review written by Kuriki et al., Chem. Rev., 102, 2347 (2002).

The processing of solid-state materials for optical applications such as telecommunications, present a range of challenges, depending on the types of materials pursued, Amorphous glasses are difficult to supercool and have poor Ln solubility. Single crystals can be chosen that offer excellent Ln solubility but are difficult to grow in large sizes and cost-effectively. Synthesizing and dispersing nano-crystals of Ln-soluble hosts in a variety of organic or inorganic matrices presents particle manipulation technological barriers related to suspension deagglomeration and colloidal stabilization to maintain particles sufficiently below 100 nm to maintain low scattering losses.

The technological barriers derive from the nanopowders and their dispersions being lyophobic colloids. By definition, they are energetically unstable because of their positive surface energy contribution at the solid-gas or solid-liquid interface. Thus, there is always a thermodynamic tendency to stabilize the system through energy minimization and flocculate the dispersed colloid species.

Lyophillic colloids with organic ligands spontaneously form true solutions through strong interaction between solvent and solute that minimizes free energy. Examples of lyophillic colloids commonly used in aqueous systems include surfactant assemblies, biomolecules, polymers and inorganic cluster compounds. Soluble inorganic cluster compounds that encompass a wide range of metal and non-metal elements within a range of cluster sizes have been designed to serve as building blocks for solid state materials via reactive pathways such as hydrolysis and polymerization.

Unfortunately, conventional Ln cluster compounds, while readily soluble in aqueous and non-aqueous solvent systems, have microsecond excited state lifetimes, which translate to low quantum efficiency. Lanthanides rely upon radiative electronic transitions utilizing their 4f-electrons. Conventional Ln cluster compounds typically contain organometallic and metal-hydroxide bonds whose phonon energies are sufficiently high to quench these transitions non-radiatively (vibronically) to reduce quantum efficiency, typically to less than 1%. The high frequency CH/OH vibrational bands of the organic ligands couple with the Ln atoms to reduce the lifetime of the emitting level by multiphonon relaxation.

While excited state lifetimes are considerably longer in solid-state materials, where low phonon energy hosts for the active ions greatly diminish multiphonon relaxation, the material processing challenges remain. A need exists for lyophillic molecular active ion cluster compounds with improved quantum efficiency.

### SUMMARY OF THE INVENTION

The present invention addresses these needs. It has now been discovered that improvements in the quantum efficiency of Ln compounds are obtained with compounds in which the Ln ions are coordinated or bound by low phonon energy ligands such as halides or chalcogenides. Compounds according to the present invention demonstrate millisecond, as opposed to microsecond, active ion excited state lifetimes.

Hydrocarbon and hydroxyl species can exist in the compound provided they do not directly participate in the nearest neighbor coordination sphere encapsulating the active ion without a low phonon energy ligand also being present. By assuming such a configuration, thermodynamic stability in organic media such as polar and non-polar liquids and polymers is feasible, which in turn yields excellent transmission characteristics because there is no second phase to scatter light.

Therefore, according to one aspect of the present invention, a thermo-dynamically stable solution is provided in which chalcogenide-bound Ln compounds with one or more Ln ions coordinated or bound by chalcogenolate, chalcogenide or polychalcogenido ligands by means of the ligand chalcogenide atom are dissolved at a level up to about 90 vol. % in a host solvent optically transparent to wavelengths at which excitation, fluorescence or luminescence of the Ln ions occur. Essentially, any material that is optically transparent as defined herein is suitable for use as the host solvent. The host solvent can be water, a polar or non-polar organic liquid, or a polymer. The Ln compounds contain both polar and non-polar species to permit the formation of thermodynamically stable solutions in both polar and non-polar solvents.

The Ln ions of the chalcogenide-bound compounds entirely reside in individual low-phonon energy chalcogenide-containing coordination spheres, and are not influenced by higher phonon energy species providing thermodynamic stability in water or organic media. Other low phonon energy ligands, such as halide ligands in which an Ln ion is coordinated or bound by the ligand halide atom, may be present as well.

Compounds according to the present invention can contain one or more Ln atoms. Cluster compounds contain more than one Ln atom. When more than one Ln atom is present, the Ln atoms may be the same or different. One example of a single-atom compound is (DME)₂Er(SC₆F₅)₃. One example of a cluster compound with a plurality of atoms is (THF)₁₄Er₁₀S₆Se₁₂I₆.

Host solvents into which the Ln compounds may be dissolved are ubiquitous. Optically transparent solvents are readily identified by one of ordinary skill in the art guided by the present specification.

Polymers suitable for use with the present invention include thermosetting and thermoplastic organic polymers free of intrinsic optical absorptions that would be a detriment to absorption, fluorescence or luminescence by Ln ions. For example, for infrared wavelengths, non-infrared absorbing polymers may be used. Each Ln compound dissolved in the polymer host may contain a different active species. The polymer solutions of the present invention are easily formed and readily fiberizable.

The solutions of the present invention exhibit broader absorption and luminescence than observed from corresponding prior art materials, in part because of the optical transparency resulting from Ln compound solubility. Photons are transmitted at a level of efficiency heretofore unseen, thereby increasing the transfer and reception of infrared signals. Furthermore, the optical transparency of the solutions permits Ln compound loading levels that further enhance this effect. Optically transparent solutions with Ln compound concentration levels as high as 90 vol. % have been attained. Higher values are possible. However, most practical applications can utilize far lower concentrations on the order of ppm levels and even lower.

This broadened emission band is advantageous for many luminescent devices, which also take advantage of the versatility of a reduced phonon energy environment. The emission band can be broadened further by combining different particle chemistries whose emissions are close to one another by virtue of the choice of host solvent or Ln ion. The emission band can also be separated into distinct spectral lines through the choice of host material or Ln ion.

Therefore, according to still another aspect of the present invention, a luminescent device is provided incorporating the thermodynamically stable solutions of the present invention. Examples of luminescent devices include zero-loss links, wavelength-division-multiplexing devices, upconversion light sources, standard light sources, and the like. Volumetric displays based on the composites of the present invention exhibit greatly enhanced performance, easier fabrication and reduced weight.

Solutions containing different Ln species exhibit ultra-broad band emissions attributable to the additive effects of the individual Ln species, all of which are transmitted with high efficiency. This broadened emissions band is advantageous for the fabrication of sources operating in wavelength-division-multiplexing schemes.

The foregoing and other objects, features and advantages of the present invention are more readily apparent from the detailed description of the preferred embodiments set forth below, taken in conjunction with the accompanying drawings.

### BRIEF DESCRIPTION OF THE DRAWINGS

FIG. 1(a) illustrates the structural configuration of an Ln cluster compound according to the present invention and FIG. 1(b) depicts more specifically the molecular structure of Nd₈O₂Se₂(SePh)₁₆;

FIG. 2 depicts the concentration dependence (millimoles) of emission bandwidth and area in a solution according to the present invention, (DME)₂Er(SC₆F₅)₃, in 5 ml of DME;

FIG. 3 depicts the absorption spectrum of a solution according to the present invention, 0.0046 M (THF)₈Nd₈O₂Se₂(SePh)₁₆ in THF with spectroscopic notation for the observed band transitions; and

FIG. 4 compares the emission spectra of Nd³⁺ for (THF)₈Nd₈O₂Se₂(SePh)₁₆ and (DME)₂Nd(SC₆F₅), with (DME)₂Nd(SC₆F₅) having the lower intensity.

### DETAILED DESCRIPTION OF THE PREFERRED EMBODIMENTS

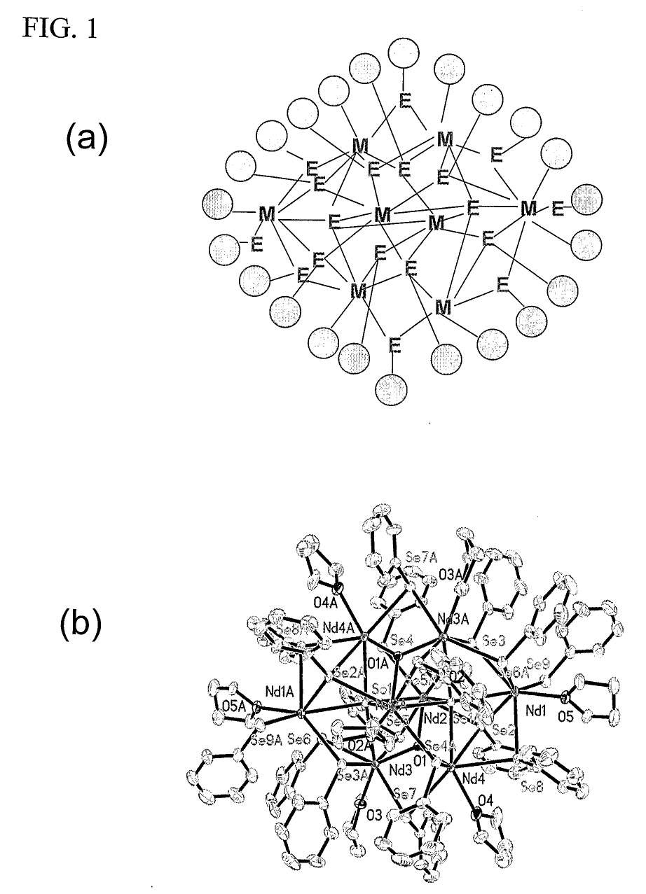

Chalcogenide-bound Ln compounds according to the present invention consist of an inorganic core and a covalently tethered organic encapsulant as shown in FIGS. 1(a) and (b). In FIG. 1(a), M represents Ln atoms, E represents chalcogenide atoms and the circles represent components of the organic encapsulant. The organic encapsulant is ligated to the inorganic core in a structured fashion, with both ionic and dative components. The compounds are typically neutral in charge and can be precipitated as single-phase systems directly from solution by regulating solvency of the molecular species. The molecular species that comprise the unit cell consist of one or more units.

The compounds can be readily recovered in single crystal form enabling precise structural determination of inorganic and organic components. Depending upon the choice of organic ligand encapsulant, solvency in both polar and non-polar media is possible.

The compounds readily dissolve as the molecular building blocks that make up the unit cell of a single crystal in both conventional solvents such as water, ethers (ie., THF, DMF, glyme, diglyme), DMSO, DME, nitrogen donor ligands (i.e., pyridine, substituted pyridines, ammonia, primary, secondary, or tertiary amines, phosphorus donor ligands (i.e. primary, secondary, or tertiary phosphines) and mixtures thereof. Organic compound with chelating, coordinating or donor properties for solvation are also suitable host solvents.

The host solvent can be liquid or solid phase. Thus, suitable solvents also include crystalline or amorphous, organic or inorganic polymers. Examples of suitable polymers include perfluorcyclobutyl (PFCB) 6F polymers, copolymers and variants thereof. Other preferred host polymers for infra-red wavelengths are functionalized polymers that have Lewis base interactions, fluoropolymers such as poly(vinyl-fluoride) and poly(vinylidenefluoride) polymers and copolymers, fluorinated polyimides, CYTOP amorphous fluoropolymers from Bellex International Corp. (Wilmington, Del.), TEFLON AF (amorphous poly(vinylfluoride)), TEFLON PFA (a perfluoroalkoxy copolymer), and the like. Other suitable polymers include acrylates (such as PMMA), halogenated acrylates, benzo-cyclobutenes, polyether-imides, siloxanes such as deuterated polysiloxanes, and the like. The polymers can be either liquid or solid at room temperature.

The host solvent should have excellent optical transparency at wavelengths at which Ln excitation, fluorescence or luminescence occurs. Polymer solvents should have good film-forming characteristics. Other properties will come into consideration, depending upon the particular end-use requirements of the materials; however, these properties are well understood by those of ordinary skill in the art.

The solubility in various media facilitates the use of well-established polymer processing techniques for device fabrication. This advantage opens up a range of materials integration opportunities that would be not possible if high temperature ceramic nanoparticle processing was necessary.

The compounds are typically dissolved in the solvent at room temperature. Inert gas blanketing should be used for materials that are oxygen- or moisture-sensitive. The solvent can be heated to promote fluidity of the solvent for mixing, especially with polymers, or to increase the solubility of the compound in the solvent.

A wide range of chalcogenide-bound Ln compounds are known. Two or more different molecules can be dissolved in the same solvent. Chalcogenides are defined as S and Se. Reported compounds are listed in Table I:

TABLE I
Summary of reported lanthanide compounds.

| Cluster | Ln | References |
|---|---|---|
| (py)₆Ln₂(Se₂)(Se)Br₂ | Ho, Er, Yb | 4 |
| (py)₈Ln₄Se₄(SePh)₄ | Yb | 15 |
| [(THF)₈Ln₄Se(SePh)₈]²⁺ | Nd, Sm | 5 |
| (py)₈Ln₈Se₆(SePh)₁₂ | Nd, Sm | 13, 17 |
| (THF)₈Ln₈S₆(SPh)₁₂ | Ce, Pr, Nd, Sm, Gd, | 14, 16 |
| | Tb, Dy, Ho, Er | |
| (py)₈Ln₈S₆(SPh)₁₂ | Nd, Sm, Er | 14 |
| (THF)₆Ln₄E₉(SC₆F₅)₂ | Tm, Yb | 6 |
| (py)₉Ln₄Te₉TePh₂ | Sm, Tb, Ho, Tm | 7 |
| (THF)₆Ln₄I₂(SeSe)₄(μ₄-Se) | Tm, Ho, Er, Tb | 8 |
| (THF)₁₀Ln₄I₆Se₆ | Yb | 8 |
| (py)₈Ln₄Se₉(EPh)₂ | Yb | 9 |
| (DME)₄Ln₄Se(SePh)₈ | Nd/Sm(III); Sm/Yb(II) | 10 |
| (THF)₆Ln₄I₂S₉ | Er, Tm, Yb | 11 |
| (py)₈Ln₄MSe₆(SePh)₄ | Er, Yb, Lu | 3 |
| (THF)₆Ln₆S₆I₆ | Er | 1 |
| [(DME)₇Ln₇S₇(SePh)₆]⁺ | Nd | 17 |
| (py)₁₀Ln₆S₆(SPh)₆ | Yb | 15 |
| (THF)₈Ln₈O₂Se₂(SePh)₁₆ | Ce, Pr, Nd, Sm | 2 |
| (THF)₁₄Ln₁₀S₆(Se₂)₆I₆ | Dy, Ho, Er | 1, 4 |
| (DME)₂Ln(SC₆F₅)₃ | Er, Nd | 12 |

E = S or Se

Single crystal x-ray methods demonstrate that the various compounds shown in Table 1 are monodisperse clusters, except for (DME)₂Ln(SC₆F₅)₃, which contains a single Ln atom. The ceramic cores of these clusters range from 0.5 to 2 nm. A variety of cluster structures and compositions have been demonstrated for mono-metallic and bimetallic complexes. The monometallic or bimetallic building blocks that make up the unit cells comprise anywhere from 1-8 molecular units, and each molecular unit has from 1-10 metal cations.

Hetero-lanthanide clusters may be prepared, in which the occupancy of the Ln sites can be controlled. This type of control of the coordination environment is not possible with the solid solutions or glasses used for conventional ceramic lanthanide hosts (e.g., selenide, sulfide). Because the distribution of species such as chalcogenides or halide species are disordered, this advantage provides a highly controlled way to introduce both cations and anions as a means to fine-tune electronic band structure, polarity and many other fundamental properties that control electronic, optical and magnetic properties.

Lanthanide species are typically dissolved into ceramic lattices or glass networks (conventional solid-state materials) where the lanthanides randomly substitute for other cation species (e.g., Er substitutes for Te in tellurite glass). This random substitution leads to clustering of lanthanides. When the lanthanide spacing is too close in such lattice clusters, lanthanides can interact to quench the excited f-electrons non-radiatively, which results in concentration quenching. The phenomenon of concentration quenching occurs through multi-polar interaction between ion pairs, matching energy levels of neighboring Lns, as described by Forster-Dexter theory. According to this theory, the probability, of this nonradiative quenching interaction is inversely proportional to the n^{th} power of the Ln-Ln separation distance of a selected Ln pair under consideration (where, n=6, 8, and 10). The n^{th} power for the interaction depends on the dominant concentration quenching mechanism, which could be one or more of the following: dipole-dipole, dipole-quadrupole, and quadrupole-quadrupole.

Generally, in lanthanide-doped crystalline materials, it is customary to define the term critical separation, Rₒ, at which the energy transfer rate approaches the radiative decay rate. The decay rate consists of radiative and non-radiative terms. At this separation distance or greater, the decay rate of a specific electronic transition can be purely radiative. However, at shorter distances, the radiative decay rate decreases and concentration quenching can begin to reduce quantum efficiency. Typically for rare-earth-doped crystals the critical separation is ˜2-2.5 nm, which corresponds to an ionic concentration of 10²⁰ ions/cc.

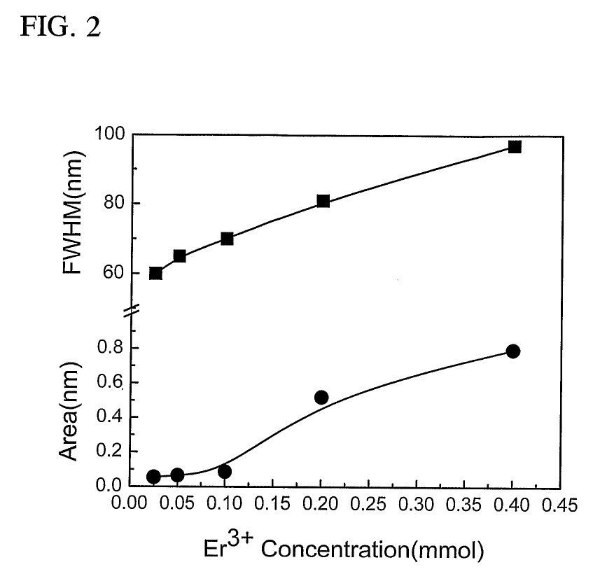

The organic ligands encapsulating the lanthanides in the compounds of the present invention provide a spacing of about 1 nm, which in a conventional solid-state material would normally be interacting. Because of this spacing, the compounds can be dissolved in solution up to their solubility limit without any evidence of concentration quenching. Thus, instead of reaching a maximum in emission intensity as a function of lanthanide concentration, the intensity can be observed to increase with increasing concentration. This is demonstrated in FIG. 2 for the (DME)₂Er(SC₆F₅)₃ complex dissolved in DME where emission peak area (also intensity) increases with increasing concentration. Lattice site spacing within the inorganic core of cluster compounds provides additional spacing.

An alternative way to improve emission intensity is to supply an appropriate lanthanide co-dopant with the primary lanthanide ion responsible for emission. Enhanced emission intensity is accomplished by non-radiative energy transfer from the co-dopant to the primary ion. Yb is a common co-dopant for enhancing Er emission in this fashion.

Luminescent devices assembled from the composite materials of the present invention are also novel and non-obvious, and meet the need for articles with luminescent properties with optical properties that do not interfere with the optical properties of the devices in which they are employed. The thermodynamically stable solutions of chalcogenide-activated Ln compounds can be employed to produce a variety of useful articles with valuable optical properties.

Solution preparation can be adapted to article fabrication, wherein articles that are formed from a polymer melt can have the Ln compounds dissolved in the melt prior to fabrication and articles that are formed by polymer solvent processing techniques can have the Ln compounds added to the polymer-solvent solution. Higher concentration polymer of solvent masterbatches of the Ln compounds can be used to dissolve the Ln compounds into the polymer to be fabricated into a luminescent optical device.

The polymer solutions can be readily processed by conventional techniques to yield optical fibers, bulk optics, films, monoliths, and the like. Optical applications include the use of the polymer solutions to form the elements of zero-loss links, upconversion light sources, standard light sources, volumetric displays, flat-panel displays, sources operating in wavelength-division-multiplexing schemes and the like.

Luminescent devices can be prepared containing a plurality of active ions that upon excitation, fluorescence, or luminescence emit a plurality of overlapping emission bands. Alternatively, luminescent device can be prepared containing a plurality of active ions that upon excitation, fluorescence or luminescence, emit a plurality of separate emission bands. Furthermore, luminescent devices can be prepared that contain a plurality of active ions that upon excitation, fluorescence or luminescence emit one or more broad-band emissions. In addition, luminescent device can be prepared that contain a plurality of active ions that upon excitation, fluorescence or luminescence emit a plurality of separate emission bands that are broad and narrow. The following luminescent devices can also be prepared:

A luminescent device where optical transmission takes place with little or no measurable scattered light.

A luminescent device where optical transmission takes place along with a noticiable amount of scatter

A luminescent device wherein the device is a fiber optic amplifier

A luminescent device that exhibits strong charge transfer UV absorption which enables excitation by UV sources to emit at longer wavelengths.

A luminescent device that exhibits UV absorption to make a low pumping threshold laser.

A luminescent device that provides a liquid laser medium that can substitute for conventional Dye lasers but unlike dye lasers show no photobleaching.

A luminescent device that can be used for making miniature optical devices like fibers, 2-D planar waveguides, and thin film electro luminescent devices, lasers, and sensors.

A luminescent device that utilize various Ln molecules to create luminescent devices with different colors in the entire UV-VIS-IR region.

A luminescent device where the emission intensity and quantum efficiency of a particular band can be increased by energy transfer sensitization synthesizing Ln Molecules with at least 2 ions such as Yb:Er, Tb:Nd, Nd:Cr, Gd:Tb, Er:Dy, Er:Ho, Er:Tm, and Nd:Yb.

Highly efficient far infrared emissive devices can be prepared for novel emission wavelengths not previously demonstrated for molecular compounds such as Pr (3-7 μm), Dy (3-5 μm); Tb (4-10 μm) and Er (2.7-4.5 μm).

A luminescent device where multiple wavelength far-infrared emission in these materials requires only one excitation wavelength, such as Pr molecules where a 1.5 μm excitation yields 3.4, 4.0, 4.8 and 5.2 μm emissions, Er molecules where an 0.8 μm excitation results in 1.5, 2.7, 3.6 and 4.5 μm emissions, Dy molecules where an 0.8 μm excitation yields 3.0, 4.5 and 5.5 μm emissions, Tb molecules where a 2 μm excitation yields 3.1, 4.8, 7.5 and 10.5 μm.

A luminescent device where changing the number of cluster atoms a molecule can change the bandwidth of the emission.

A luminescent device where mixtures of various Ln molecules (e.g., (Yb molecules mixed with Tm Molecules), (Er Molecules mixed with Eu Molecules) can yield white light emission with a single excitation wavelength in the near-infrared region.

A luminescent device where NIR excitation can generate strong upconversion emissions in the visible regions that can be used as taggants, displays, and infrared-pumped visible lasers.

Solutions of Er and Nd-containing compounds have important photonic applications such as low power lasers and active fibers and waveguides. A summary of the optical properties of Nd complexes is given in Table 2 in comparison with the well-known laser host Nd:YAG:

TABLE 2
Fluorescence spectral properties of (DME)₂Nd(SC₆F₅)₃ (Nd1) and
(THF)₈Nd₈O₂Se₂(SePh)₁₆ (Nd8) clusters and Nd:YAG single crystals.

| Transition | | | τ_{fl} (μs)^{†} | | | σₑ (10⁻²⁰ cm²)^{#} | | |
|---|---|---|---|---|---|---|---|---|
| from ⁴F_{3/2} to | Wavelength (nm) | βₑₓ* (%) | Nd8 | Nd1 | YAG | Nd8 | Nd1 | YAG |
| ⁴I_{15/2} | 1843 | 9 | | | | 0.0138 | 0.0092 | — |
| ⁴I_{13/2} | 1360 | 14 | 186 | 111 | 259 | 0.29 | 0.30 | 6.0 |
| ⁴I_{11/2} | 1078 | 72 | | | | 3.04 | 1.61 | 22.0 |
| ⁴I_{9/2} | 927 | 6 | | | | 1.72 | 0.71 | 4.0 |

*measured fluorescence branching ratio
^{†}fluorescence decay time
^{#}stimulated emission cross-section

The stimulated emission cross section, σₑ, is an important optical parameter that defines the optical gain of the amplifier system. σₑ is more than seven times higher in Nd:YAG compared to (THF)₈Nd₈O₂Se₂(SePh)₁₆. (THF)₈Nd₈O₂Se₂(SePh)₁₆ and (DME)₂Nd(SC₆F₅)₃ nevertheless have significantly higher lanthanide concentrations, which are as much as ˜14 times higher than Nd:YAG (19×10²⁰ ions/cc in (THF)₈Nd₈O₂Se₂(SePh)₁₆, 13×10²⁰ ions/cc in (DME)₂Nd(SC₆F₅)₃ and 1.4×10²⁰ ions per cc in Nd:YAG). Thus, the lower σₑ values for the Nd solutions are amply compensated by their higher lanthanide concentrations, enabling them to be suitable candidates for laser and amplifier applications in bulk, fiber or thin film form. Moreover these devices can be processed with low temperature solutions instead of the high temperature processes needed for materials such as YAG.

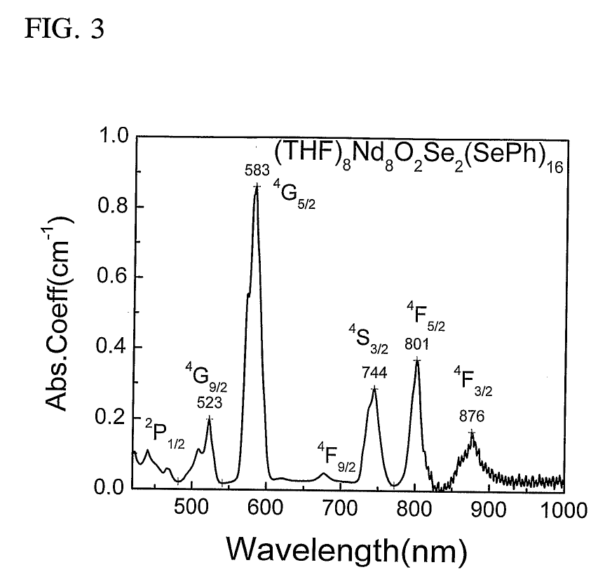

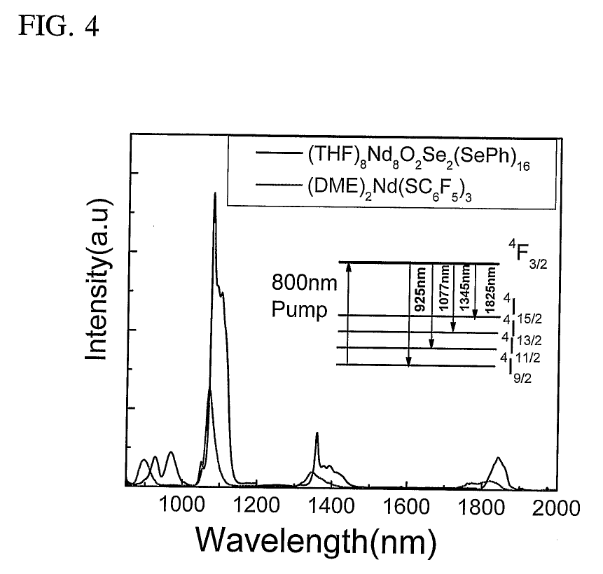

A typical absorption and emission spectra of the (THF)₈Nd₈O₂Se₂(SePh)₁₆ complex is shown in FIGS. 3 and 4. Both the absorption and emission spectra are similar to the solid-state materials in terms of the spectral intensity, width and Stark splitting (a multiple division of the spectral band due to the electrostatic field from surrounding ligands). One unexpected result is an emission band at 1850 nm. This band has never been observed in a high phonon energy host like an oxide but has been observed in Nd-doped ZBLAN glass. This is attributable to the low phonon energy coordination environment for the Nd, which prevents the non-radiative decay of the 1850 nm band. Fluorescence quantum efficiencies of 16 and 9% are obtained for the 1060 nm emission for (THF)₈Nd₈O₂Se₂(SePh)₁₆ and (DME)₂Nd(SC₆F₅)₃, respectively. These values are the highest reported efficiencies for molecular Nd compounds. Earlier, Hasegawa et al., Agnew. Chem. Int. Ed., 39, 357-360 (2000) obtained a decay time of 13 μs and a quantum efficiency of 3.2% for Nd (bis-perfluorooctanesulfonylimide)₃. Other workers report quantum efficiencies in the range of 0.001 to 0.1%.

Planar wave-guide structures capable of optical amplification at 1550 nm can be fabricated from Er compounds with threshold pump power values many times smaller than other reported Er-based organic complexes and comparable to inorganic systems like Er-doped silicate or Er-doped Al₂O₃ waveguides and Er-doped CaF₂:Er/6F PFCB fluoropolymer nanocomposite. The low pump threshold and high gain are potentially useful for the application of optical amplifiers. The addition of Yb³⁺ in selected lattice positions of Er cluster compounds further increase the optical gain.

The following non-limiting examples set forth below illustrate certain aspects of the invention. All parts and percentages are molar unless otherwise noted and all temperatures are in degrees Celsius.

### EXAMPLES

### General Methods

All syntheses were carried out under ultra pure nitrogen (WELCO CGI, Pine Brook, N.J.), using conventional dry box or Schlenk techniques. Solvents (Fisher Scientific, Agawam, Mass.) were refluxed continuously over molten alkali metals or K/benzophenone and collected immediately prior to use or purified with a dual-column Solv-Tek solvent purification system (Solv-Tek Inc., Berryville, Va.). Er and Hg were purchased from Strem Chemicals (Newburyport, Mass.). HSC₆F₅ was purchased from Aldrich. Anhydrous pyridine (Aldrich Chemicals, Milwaukee, Wis.) was purchased and refluxed over KOH (Aldrich). (THF)₁₄Er₁₀S₆Se₁₂I₆ was prepared according to literature procedure²¹ while (DME)₂Er(SC₆F₅)₃ was prepared with a modified version of the preparation disclosed by Melman, et al., Inorg. Chem., 41, 28 (2002) as follows.

Synthesis of (DME)₂Er(SC₆F₅)₃:

Er (0.171 g, 1.02 mmol) and Hg(SC₆F₅)₂ (0.961 g, 1.61 mmol) were combined in DME (ca. 30 mL) and the mixture was stirred at room temperature until all the Er dissolved and shiny metallic Hg (0.31 g, 96%) was collected at the bottom of the flask. The resultant light pink colored solution was filtered away under dry nitrogen, reduced in volume to ˜20 mL, and layered with 10 mL of hexane to give pink crystals (0.876 g, 93%) that were identified by melting point (215° C.), compared with the published IR spectra, and had their unit cell determined with x-ray diffraction.

Spectroscopy:

Absorption measurements were carried out with crystalline powder dissolved in THF using a double beam spectrophotometer (Perkin Elmer Lambda 9, Wellesley, Mass.) in 1 cm cuvette using THF as the reference solvent. The emission spectra of the powdered samples were recorded by exciting the sample with 980 nm band of a laser diode in the 90°-excitation geometry. The diode current was kept at 960 mA throughout the experiment to maintain the same excitation laser power. The emission from the sample was focused onto a 1 m monochromator (Jobin Yvon, Triax 550, Edison, N.J.) and detected by a thermoelectrically cooled InGaAs detector. The signal was intensified with a lock-in amplifier (SR 850 DSP, Stanford Research System, Sunnyvale, Calif.) and processed with a computer controlled by the Spectramax commercial software (GRAMS 32, Galactic Corp, Salem, N.H.). To measure the decay time, the laser beam was modulated at 32 Hz by a chopper and the signal was collected on a digital oscilloscope (Model 54520A, 500 MHz, Hewlett Packard, Palo Alto, Calif.).

Data Analysis:

The radiative lifetime (τ_{RAD}) of the infrared emitting state is related to the total spontaneous emission probability of all the transitions from an excited state by τ_{RAD}=(ΣA_{J′J}⁾⁻¹ where A is calculated using Judd-Ofelt theory as

$${A}_{rad} ( i \to j ) = \frac{64 {π}^{4}}{3 h ( 2 J + 1 ) {ⅇ}^{2} {λ}^{3}} \times [ \frac{{n ( {n}^{2} + 2 )}^{2}}{9} ] {\sum }_{i = 2 , 4 , 6} {Ω}_{i} {〈 {}_{}^{4}{I}{}_{13 / 2}^{} {‖ {U}^{i} ‖}^{} {}_{}^{4}{I}{}_{15 / 2}^{} 〉}^{2} \qquad 1$$

where n is the refractive index, Ωᵢ are the Judd-Ofelt intensity parameters and ∥U^{t}∥ are doubly reduced matrix elements operators corresponding to J→J′ transition. The three Judd-Ofelt parameters were obtained by fitting the measured oscillator strength to the theoretical oscillator strength using the least squares technique. The stimulated emission cross section of the 1544 nm band is obtained with the help of the Fuchtbauer-Ladenburg equation

$${σ}_{em} = \frac{{λ}^{4} A}{8 π {cn}^{2} Δ {λ}_{eff}} , \qquad 2$$

where Δλ_{eff} is the effective line-width of the emission band obtained by integrating over the entire emission band and dividing by the peak fluorescence intensity.

The lifetime of the emission band is extracted from the decay curve by fitting with the following equation in Monte Carlo (MC) energy transfer model
where, W_{DA} is the donor to acceptor energy transfer rate separated by the distance Rᵢⱼ._The major contribution of W_{DA} is from multi-polar (W_{MP}), exchange (W_{EX}) or a

$${I}_{i} ( t ) = exp ( - \begin{matrix}t \\ τ\end{matrix} ) {\prod }_{j = 1}^{{N}_{A}} exp [ - {W}_{DA} ( {R}_{i} - {R}_{j} ) t ] \qquad 3$$

combination of both. The multi-polar interaction rate is obtained from the well know Forster-Dexter model as follows
4
where, R₀ is the critical donor-acceptor separation and τ_{0D} is the decay time of the donor emission in the absence of energy transfer (lowest concentration limit). The exchange interaction is evaluated as follows where, γ=2R₀/L; R₀ is the penetration depth of exchange interaction and L is the effective Bohr radius.

$${W}_{EX} = \begin{matrix}1 \\ {τ}_{0 D}\end{matrix} exp [ γ ( 1 - \begin{matrix}{R}_{ij} \\ {R}_{0}\end{matrix} ) ] \qquad 5$$

Results:

In the 400 to 1600 nm region, various f→f absorption bands of Er³⁺ were observed, where the strongest is in the 516 nm region. These bands originate from the ⁴I_{15/2} ground state of Er³⁺ and the standard notations identify the different transitions. All the observed absorption bands were numerically integrated to obtain the experimental oscillator strength given by equation (1) and the calculated values were summarized in Table 3 along with the observed band positions and their spectral assignments. These values were comparable to those of Er³⁺ in many reported inorganic materials. The measured line strengths were fitted with equation (2) to obtain the three phenomenological intensity parameters Ω₂, Ω₄, Ω₆ with corresponding values of 8.9×10⁻²⁰ cm², 2.08×10²⁰ cm² and 3.75×10⁻²⁰ cm². The calculated intensity parameters were used to evaluate the transition probability and radiative decay time for the infrared band of interest.

TABLE 3

| | | Integrated | | |
|---|---|---|---|---|
| Transition | Transition | absorption | ¹Sₘₑₐₛ | ²S_{cal} |
| from ⁴I_{15/2} to | energy (cm⁻¹) | (10⁻⁷) | (10⁻²⁰ cm²) | (10⁻²⁰ cm²) |
| ⁴F_{7/2} | 483 | 7.8 | 2.39 | 2.61 |
| ²H_{11/2} | 515 | 26.34 | 7.56 | 7.51 |
| ⁴S_{3/2} | 539 | 6.9 | 0.89 | 0.81 |
| ⁴F_{9/2} | 649 | 11.95 | 2.73 | 2.77 |
| ⁴I_{9/2} | 800 | 5.25 | 0.47 | 0.38 |
| ⁴I_{11/2} | 976 | 10.65 | 1.62 | 1.71 |
| ⁴I_{13/2} | 1527 | 59.0 | 5.72 | 5.70 |

Ω₂ = 8.9 × 10⁻²⁰ cm², Ω₄ = 2.0 × 10⁻²⁰ cm², Ω₆ = 3.7 × 10⁻²⁰ cm², ΔSᵣₘₛ = 0.61 × 10⁻²⁰ cm²
¹Measured electric dipole line strength,
²Calculated electric dipole line strength

The ⁴I_{13/2}→⁴I_{15/2} transition is responsible for the observed 1544 nm emission. Consequently, the radiative decay time is required for evaluating the quantum efficiency. The calculated radiative decay time of 3.85 ms is in excellent agreement with the reported value of 4 ms in Er organic complexes. In order to measure the quantum efficiency the fluorescence decay time (τ_{fl}) was extracted from the measured decay curve. Using Monte Carlo (MC) methods decay times of 3 ms and 2.88 ms are obtained for (THF)₁₄Er₁₀S₆Se₁₂I₆ and (DME)₂Er(SC₆F₅)₃ respectively. These, together with the calculated radiative decay time, produce calculated quantum efficiencies of 78% and 75%, respectively. These values are the highest reported efficiencies for molecular compounds.

The 1544 nm emission decay time for all reported organic complexes are in the microsecond regime, leading to low reported quantum efficiencies, which range from 0.1-0.01%. The reported millisecond emission lifetime is typical of a low phonon energy host, which is supported by Table 4 where the emission lifetimes of various classes of low phonon energy hosts are summarized, and found to range from 2.3 to 30 ms. More specifically, Er ions encapsulated by selenide, sulfide or iodide have lifetimes that ranges from 2.3 to 4 ms.

TABLE 4

| Host | Lifetime (ms) | Phonon freq. (cm⁻¹) |
|---|---|---|
| Sulphide | 3.0 | 450-700 |
| Selenide | 2.3 | 450-700 |
| Tellurite | 4 | 450-700 |
| Germanate | 6 | 900 |
| ZBLA Fluoride Glass | 10 | 500 |
| Fluorides, Chlorides | 10-30 | 200-400 |
| Yttrium Aluminum Garnet | 8 | 400 |

The high decay times in the present organometallic complexes are attributed to low fluorescence quenching, which arises from multiphonon relaxation from the high frequency vibrational bands that are not directly attached to the Er ion. In Er³⁺ compounds one of the principle channels of multiphonon non-radiative decay is via ⁴I_{11/2}→⁴I_{13/2}, which is in the frequency region of 3700 cm⁻¹. The non-radiative channel can reduce the effective population density at ⁴I_{13/2} and hence the fluorescence decay time and efficiency of the 1540 nm emission. Similarly the population of the ⁴I_{13/2} state during the ⁴I_{13/2}→⁴I_{15/2} decay can be further lost by vibrational groups of frequency 6500 cm⁻¹.

If Er³⁺ is directly attached to any of these vibrational groups or its harmonics higher non-radiative loss can be expected with low quantum efficiency as observed in all Er organic complexes reported so far. In most molecular Er complexes the two main vibrational groups quenching the fluorescence efficiency of Er³⁺ are C—H and O—H. The second order vibrational energy of C—H (2960 cm⁻¹) is resonant with the Er³⁺ first excited state (6500 cm⁻¹). Similarly O—H is a potential quencher of Er lumenescence, because its first vibrational overtone (3400 cm⁻¹) is strongly resonant with the ⁴I_{13/2}→⁴I_{15/2} transition (6500 cm⁻¹). In both Er compounds there are no OH functionalities, and the limited number of ligands with CH bonds are connected to the Ln through weak dative interactions, rather than direct coupling between the metal cation and an anionic ligand.

The infrared absorption spectrum of the metal complexes show an absence of C—H vibrational groups near the Er³⁺ ions. In both complexes the Ln are bound most strongly to heavy elements such as S, Se, I and fluorinated thiolates and the proximity of such heavy elements and fluorinated organic functionalities produces high fluorescence quantum efficiency.

The present invention thus provides, among other embodiments, chalcogen bound Er ions that emit strongly at 1544 nm in crystalline forms with quantum efficiency comparable to inorganic hosts. Fluorescence quenching is minimized by the absence of OH functional groups and a minimization of ligands containing C—H bonds, resulting in currently the most efficient molecular Er source of 1544 nm emission.

The foregoing examples and description of the preferred embodiment should be taken as illustrating, rather than as limiting, the present invention as defined by the claims. As would be readily appreciated, numerous variations and combinations of the features set forth above can be utilized without departing from the present invention as set forth in the claims. Such variations are not regarded as a departure from the spirit and scope of the invention, and all such variations are intended to be included within the scope of the following claims.

### REFERENCES

¹A. Kornienko et al., J. Amer. Chem. Soc., 127, 3501-5 (2005).
²S. Banerjee et al., J. Am. Chem. Soc., 127, 15900-15906 (2005).
³A. Kornienko et al., J. Am. Chem. Soc., 127, 14008-14 (2005).
⁴L. Huebner, et al., Inorg. Chem., 44, 5118-5122 (2005).
⁵A. Kornienko, et al., Inorg. Chem., 42, 8476-80 (2003).
⁶M. Fitzgerald, et al., Inorg. Chem., 41, 3528-33 (2002).
⁷D. Freedman, et al., Inorg. Chem., 41, 492-500 (2002).
⁸A. Kornienko, et al., Inorg. Chem., 41, 121-126 (2002).
⁹A. Kornienko, et al., J. Am. Chem. Soc., 123, 11933-11939 (2001).
¹⁰D. Freedman, et al., J. Am. Chem. Soc. 121, 11713-9 (1999).
¹¹J. Melman et al., J. Am. Chem. Soc., 121, 10247-8 (1999).
¹²J. Melman, et al., Inorg. Chem., 41, 28 (2002).
¹³D. Freedman, et al., Inorg. Chem., 38, 4400-4 (1999).
¹⁴J. Melman et al., Inorg. Chem., 38, 2117-22 (1999).
¹⁵D. Freedman, et al., Inorg. Chem., 37, 4162-3 (1998).
¹⁶J. Melman, et al., Chem. Commun., 2269-70 (1997).
¹⁷D. Freedman, et al., J. Am. Chem. Soc., 119, 11112-3 (1997).

What is claimed is:

1. A thermodynamically stable solution comprising chalcogenide-bound Ln compounds with one or more Ln ions coordinated or bound by chalcogenolate, chalcogenide or poly-chalcogenido ligands by means of the ligand chalcogenide atom, wherein said Ln compounds are dissolved at a level up to about 90 vol. % in a host solvent optically transparent to wavelengths at which excitation, fluorescence or luminescence of the Ln ions occurs.

2. The solution of claim 1, wherein said host solvent is selected from the group consisting of water, organic solvents and optically transparent organic and inorganic polymers.

3. The solution of claim 1, wherein said host solvent is a solid or liquid phase material.

4. The solution of claim 1, where said host solvent is a crystalline or amorphous solid.

5.-8. (canceled)

9. The solution of claim 1, wherein said host solvent has chelating, coordinating or donor properties for salvation

10. The solution of claim 1, wherein said host solvent is a polymer.

11.-13. (canceled)

14. The solution of claim 10, wherein said polymer is a fluoropolymer.

15.-17. (canceled)

18. The solution of claim 1, wherein said Ln compound contains at least one atom selected from the group consisting of Dy, Ho, Er, Yb, Nd, Sm, La, Ce, Pr, Pm, Eu, Gd, Tb, Tm and Lu.

19. (canceled)

20. The solution of claim 18, wherein said Ln compound is a cluster compound selected from (THF)ₛLn₈S₆(SPh)₁₂ and (THF)₁₄Ln₁₀S₆(Se₂)₆I₆ and Ln is selected from the group consisting of Dy, Ho and Er.

21.-24. (canceled)

25. The solution of claim 1, wherein at least one Ln ion is coordinated or bound by a thiolate, sulfide, selenolate, selenido, polyselenido ligand, or polysulfido ligand.

26. (canceled)

27. The solution of claim 1, wherein said Ln compound comprises two or more different Ln molecules.

28. A luminescent device comprising an optical element formed from the solution of claim 1.

29. (canceled)

30. The luminescent device of claim 28 comprising a plurality of active ions that upon excitation, fluorescence, or luminescence emit a plurality of overlapping emission bands.

31. The luminescent device of claim 28, comprising a plurality of active ions that upon excitation, fluorescence or luminescence, emit a plurality of separate emission bands.

32. The luminescent device of claim 28, comprising a plurality of active ions that upon excitation, fluorescence or luminescence emit one or more broad-band emissions.

33. The luminescent device of claim 28, comprising a plurality of active ions that upon excitation, fluorescence or luminescence emit a plurality of separate emission bands that are broad and narrow.

34. (canceled)

35. A waveguide characterized by an optical element formed from an Ln compound according to claim 22.

36. A laser or light amplifier characterized by an optical element formed from an Ln compound according to claim 24.

37. The luminescent device of claim 28, where optical transmission takes place with essentially no measurable scattered light.

38. (canceled)

39. The luminescent device of claim 37, wherein device is a fiber optic amplifier.

40.-44. (canceled)

45. The luminescent device of claim 31 comprising a plurality of Ln molecules that emit at least one UV wavelength, at least one one visible wavelength and at least one IR wavelength.

46. The luminescent device of claim 28, comprising Ln molecules containing at least one 2 ion pair selected from the group consisting of Yb:Er, Tb:Nd, Nd:Cr, Gd:Tb, Er:Dy, Er:Ho, Er:Tm and Nd:Yb.

47. The luminescent device of claim 28, comprising an Ln compound selected from the group consisting of Pr compounds emitting between 3-7 μm, Dy compounds emitting between 3-5 μm, Tb compounds emitting between 4-10 μm and Er compounds emitting between 2.7-4.5 μm.

48. The luminescent device of claim 28, comprising an Ln compound selected from the group consisting of Pr compounds in which a 1.5 μm excitation yields 3.4, 4.0, 4.8 and 5.2 μm emissions, Er compounds in which a 0.8 μm excita-tion results in 1.5, 2.7, 3.6 and 4.5 μm emissions, Dy compounds in which a 0.8 μm excitation yields 3.0, 4.5 and 5.5 μm emissions, and Tb compounds in which a 2 μm excitation yields 3.1, 4.8, 7.5 and 10.5 μm emissions.

49. The luminescent device of claim 28, comprising a mixture of Ln com-pounds that emit white light upon excitation with a single near-infrared wavelength.
